(19) United States
(12) Patent Application Publication
(10) Pub. No.: US 2005/0114203 A1
(43) Pub. Date: May 26, 2005

(54) Career planning tool

(76) Inventors: Terrance Savitsky, Cambridge, MA (US); Kathleen L. McGirr, Milton, MA (US)

Correspondence Address: FISH & RICHARDSON PC, 225 FRANKLIN ST, BOSTON, MA, 02110, US

(21) Appl. No.: 10/720,451

(22) Filed: Nov. 24, 2003

(51) Int. Cl. G06F 17/60

(52) U.S. Cl. 705/11

(57) ABSTRACT

Systems, including computer program products, and methods for career planning are described. The techniques described include storing a set of roles for an organization, storing user information for a user, the user information including a first role and a second, later role, and automatically generating a career path based on the set of roles, the first role, and the second role.

### TECHNICAL FIELD

This description relates to a career planning tool.

### BACKGROUND

Typically, career progression occurs at a large company by an employee being promoted from a position he currently has. If the employee wants to try something different, he must try to find a job opening in another department using some kind of job postings, either a bulletin board or some intranet posting, or word of mouth from other employees.

### SUMMARY

In one aspect, there are systems and methods that include storing a set of roles for an organization, storing user information for a user, the user information including a first role and a second, later role, and automatically generating a career path based on the set of roles, the first role, and the second role.

Other embodiments may also include one or more of the following features. The method/system may include generating a training recommendation based on the career path. The method/system may include comparing a first set of qualification data included in role information for a role in the career path with a second set of qualification data included in the user information, and identifying a qualification included in the first set of qualification data but not in the second set of qualification data. Generating a training recommendation may include determining an association between the qualification and a training program. The career path may include a set of intermediate roles between the current role and the second role. The method/system may include providing a list of roles from the set of roles. Storing the user information may include displaying available roles from a list of roles and receiving a user selection from the displayed available roles. The method/system may include sorting roles from the set of roles according to qualification data and selecting roles with a particular set of qualifications. Determining the second role may include receiving a user input. The method/system may include saving the career path and/or sending the career path associated with the user to a second user. The second user can be a manager and/or a human resources employee.

In another aspect, there are systems and a methods that include providing links between roles that may be part of a career path, receiving a first role and a second role based on to user input, and generating a career path including a set of roles between the first role and the second role based on the links between roles.

Embodiments may include one or more of the following features. The links can include binary links. The method/system may include displaying the set of roles to a user. The method/system may include determining a path with the least number of roles between a first role and a second role. The method/system may include determining a path with a typical progression of roles between a first role and a second role. The method/system may include determining a plurality of paths between a first role and a second role. The method/system may include receiving a path selection corresponding to user input.

The method/system may include using a job category to obtain the second role corresponding to the user input. The method/system may include using job family within a job category to obtain the second role corresponding to the user input. The method/system may include determining the links between roles based on skill and competency measures.

In another aspect, there are systems and methods that include providing a list of roles, providing rules to govern links between roles, and generating a career path between a first role and a second role based on the rules.

Other embodiments may also include one or more of the following features. The method/system may include generating the rules based on a possible progression between two roles. The rules can include skill set data, competency measures, and/or certifications. Providing rules may include receiving rules based on a user input. The method/system may include providing a second set of rules corresponding to an accelerated path. The accelerated path can include less intermediate roles than a typical career path. The method/system may include generating a set of links between two roles such that no rules are violated. The method/system may include generating a list of training suggestions for a progression from a fist role to a second role.

In another aspect, there are systems and methods that include providing a plurality of backgrounds, each background associated with a respective employee, sorting the backgrounds by role, and sending backgrounds to a user in response to user input.

Other embodiments may also include one or more of the following features. The method/system may include selecting a role and set of backgrounds based on user input. The method/system may include contacting the employee associated with a particular background. Contacting the employee can include e-mailing and/or establishing an internet chat session. The method/system may include allowing the employee to select whether their background information can be viewed by other users. The method/system may include displaying job openings associated with a role in the career path.

In another aspect, there are computer program products, tangibly embodied in an information carrier, for career planning, the computer program products being operable to cause data processing apparatus to implement any of the above methods and features.

Other features of the invention will be apparent from the following description and from the claims.

### DESCRIPTION OF DRAWINGS

FIG. 1 is a screen shot of a career planning tool.

FIG. 2 is a screen shot of a career path.

FIG. 3 is a diagram of an organization.

FIG. 4 is a block diagram of a role.

FIG. 5 is a screen shot of a background.

FIG. 6 is a screen shot of methods for generating a career path.

FIG. 7 is a block diagram of a guided mode.

FIG. 8 is a screen shot of an explorer method.

FIG. 9 is a screen shot of a role matchmaker.

FIG. 10 is a screen shot of the role matchmaker administrator tool.

FIG. 11 is a screen shot of a development plan.

FIG. 12 is a screen shot of an employee profile.

### DETAILED DESCRIPTION

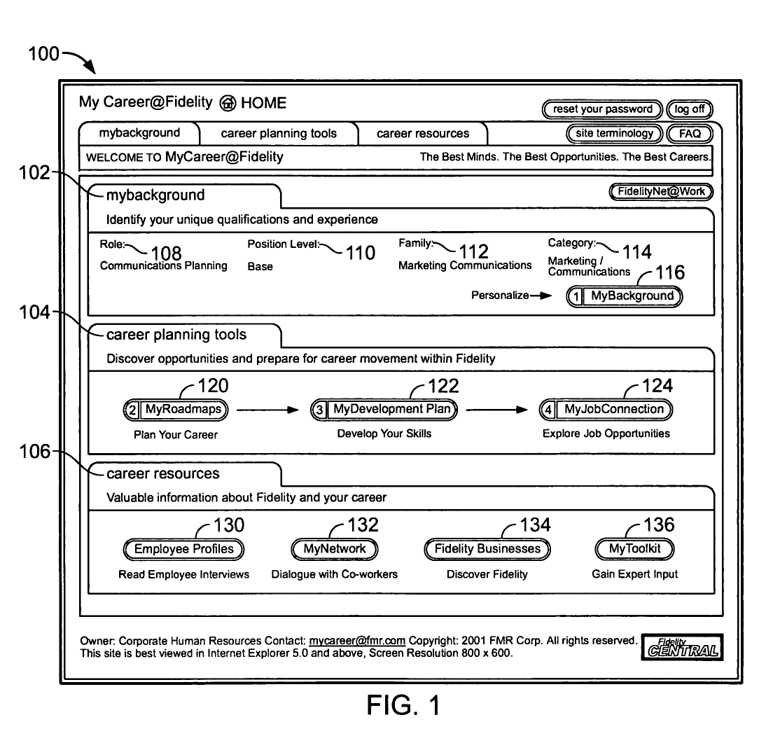

FIG. 1 illustrates a screenshot 100 for assisting a user to plan a career path within the organization at which the user works. A career planning software tool running on a network generates screenshot 100 and the other screenshots described below. Screenshot 100 includes a background section 102, a career planning section 104, and a career resources section 106. An employee uses each section independently, or in conjunction with the results and information included in another section.

The background section 102 includes a role 108 (e.g., IT technician), a position 110 (e.g., entry level), a family 112 (e.g., IT help services), and a category 114 (e.g., IT) associated with a current role of a user. The background section 102 includes a hyper-link 116 for a user to personalize the background of that particular user. For example, the user can personalize the background by adding additional information about education, training, previous roles, and the like. The user can also personalize the background to update the role 108, position level 110, family 112, or category 114 listed for the user's current job status.

The career planning section 104 of the career planning tool uses information included in background section 102 to determine a career path. Career planning section 104 includes a career path hyper-link 120, a development plan hyper-link 122, and a job connection hyper-link 124. When a user clicks on the career path hyper-link 120, the career planning tool accesses a career path section that generates a career path based on a current role and a desired role input by a user. When a user clicks on the development plan hyper-link 122, the career planning tool accesses a development plan section that provides recommendations for training based on skills required or desired for a subsequent role on the employee's career path. When a user clicks on job connection hyper-link 124, the career planning tool accesses a job connection section that provides a listing of job opportunities currently available. The career planning tool displays complete listing of jobs or the career planning tool queries the list to display jobs associated with a particular role on a career path.

The career resources section 106 provides additional information about a particular role. The career resources section 106 includes a hyper-link 130 to a section including employee profiles, a hyper-link 132 to a section including a network connection, a hyper-link 134 to a section including business description, and a hyper-link 136 to a section including a toolkit. Employee profiles (accessed by a user selecting hyper-link 130) include employee interviews allowing the user to obtain a description of a particular role generated by another employee in that particular role. Clicking on the network connection hyper-link 132 allows the user to view the background information of other employees, sorted by a particular role. The business section (accessed by a user clicking on hyper-link 134) includes a description of some aspect of the company, role, or business. The toolkit (accessed by a user clicking on hyper-link 136) includes general information to help a user progress. For example, the toolkit can include a resume-building tool or interviewing and networking tips.

Each of the hyper-links on FIG. 1 and other figures, when clicked invokes another screen that enables a user to perform various functions. Note that the tabs on the screen provide another way to navigate to another screen.

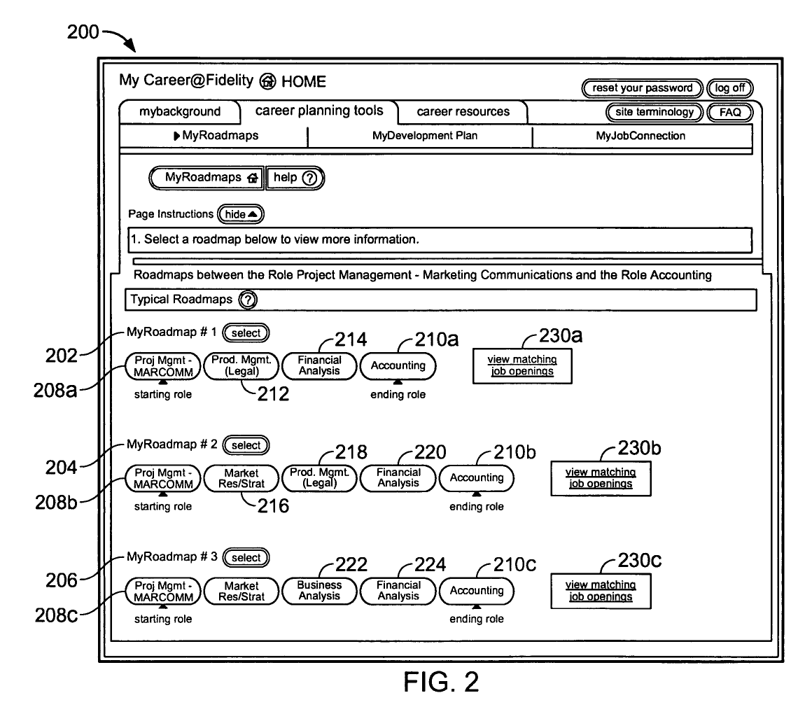

FIG. 2 illustrates a screenshot 200 of a user interface that the career planning tool displays when the user clicks on hyper-link 120. Screenshot 200 includes career paths 202, 204, and 206 (also referred to as roadmaps). Each career path 202, 204, and 206 includes roles. One or more intermediate roles (212, 214, 216, 218, 220, 222, 224, and 226) connect a starting role 208 (e.g., 208a, 208b, or 208c) to a desired role 210 (e.g., 210a, 210b, or 210c) to form the career path. Screenshot 200 also includes hyper-links 230a, 230b, and 230c to job openings. Career paths 202, 204, and 206 each show a suggested path between the current role 208 (also referred to as a starting role) and the desired role 210 (also referred to as an ending role). The use of a career path enables an employee to select the desired role 210 and direct his movement within the company toward desired role 210. The number and type of intermediate roles varies among career paths. The desired position can be multiple roles away from the current role or can be only a single role away. For example, career path 202 includes two intermediate roles 212 and 214, while career path 204 includes three intermediate roles 216, 218, and 220. The generation of multiple career paths (e.g. 202, 204, and 206) between two roles allows a user to chose the most appealing career path. A user selects a career path by pressing the select button 240, 242, or 244 associated with the career path. A user can also view job openings for a role on a career path by clicking on one of the hyper-links 230 to job openings. While, in this example, the career planning tool generates three career paths and displays the career paths to the user, the number of career paths the career planning tool generates and displays varies depending on the preferences of the user, starting role 208 and desired role 210.

In the illustrated example, an employee is currently in a project management role (starting role 208) and desires to eventually work in an accounting role (desired role 210). A typical career path 204 directs an employee to progress from the current project management role (starting role 208b) to intermediate role 216, a market research/strategy (Res/Strat) role. From intermediate role 216, the user progresses to another intermediate role 218, a Product management (Prod. Mgmt) Legal role, to a financial analysis role 220 and finally to the desired role 210b, an accounting role. While career path 204 provides the typical progression between the starting role 208b and the desired role 210b, a user may not find this career path particularly appealing and can select a different career path. The user can desire a more focused or “shortest” career path 202 (also referred to as an accelerated career path) between starting role 208a and desired role 210a. In this example, shortest path 202 progresses directly from the current project management marketing and communications (MARCOMM) role 208a to a Prod. MgmtLegal role 212, skipping the market Res/Strat role 216 entirely. Thus, career path 202 eliminates one of the intermediate roles from career path 204. A third career path 206 suggests a progression similar to the typical path 204 but includes slightly different intermediate roles. In this career path, the role of business analysis 224 replaces the role of Product management legal 218.

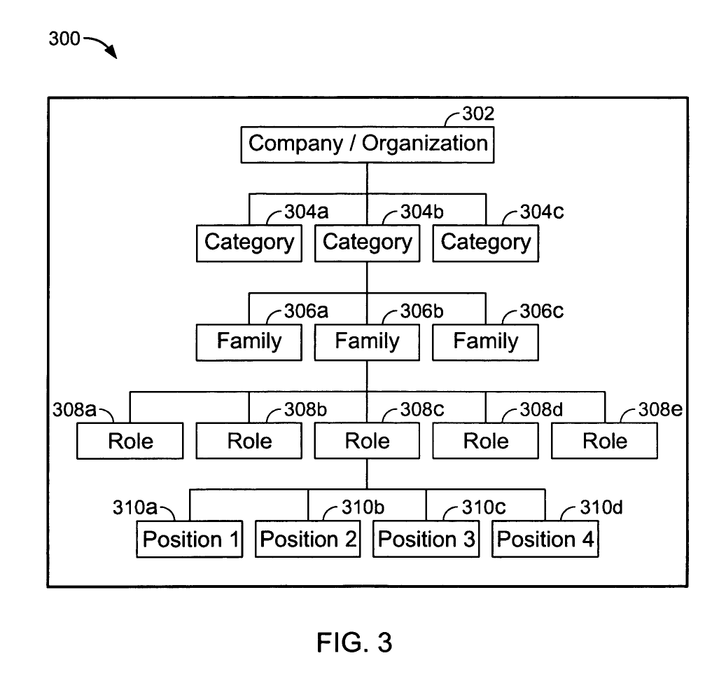

FIG. 3 illustrates how roles fit into a hierarchical taxonomy 300 of a particular organization 302. In order to make the number and variety of roles manageable and to provide a user-friendly interface, the organization 302 is divided into categories 304a, 304b, and 304c (generally categories 304). Category 304b is divided into families 306a, 306b, and 306c (generally families 306). A family, for example family 306b, is divided into roles 308a, 308b, 308c, 308d, and 308e (generally roles 308). A role, for example role 308c is divided into positions 310a, 310b, 310c, and 310d (generally positions 310).

As described above, the career planning tool most broadly divides the organization 302 into categories 304. For example, categories 304 can be broad divisions such as engineering, human resources, and accounting. The career planning tool divides each category 304 into families 306. For example, the engineering family can be divided into electrical engineering, software engineering, and mechanical engineering. Each family 306 is further divided into roles 308. For example, the electrical engineering family can include roles 308 such as hardware designer and process integration engineer. Each role 308 includes a predetermined number of positions 310. Positions 310 specify the level of experience of the employee in the particular role. For example, the role can be broken down into four positions such that position 310a is an entry position, position 310b is an intermediate position, position 310c is an advanced position, and position 310d is a managerial position. While in this example a role 308 includes four positions 310a, 310b, 310c, and 310d, the number of positions can vary depending on the role 308 or the organization 302. In some examples, an administrator of the career planning tool enters a taxonomy 300 for organization 302 into a storage module (e.g., a database) to which the career planning tool has access.

For example, an employee working at a support desk answering telephone calls for computer support might be classified in the category 304 of Information Technology, family 306 of technical support, and role 308 of support desk. The career planning tool assigns the employee's position as an intermediate level position 310b based on the employee's seniority within the role.

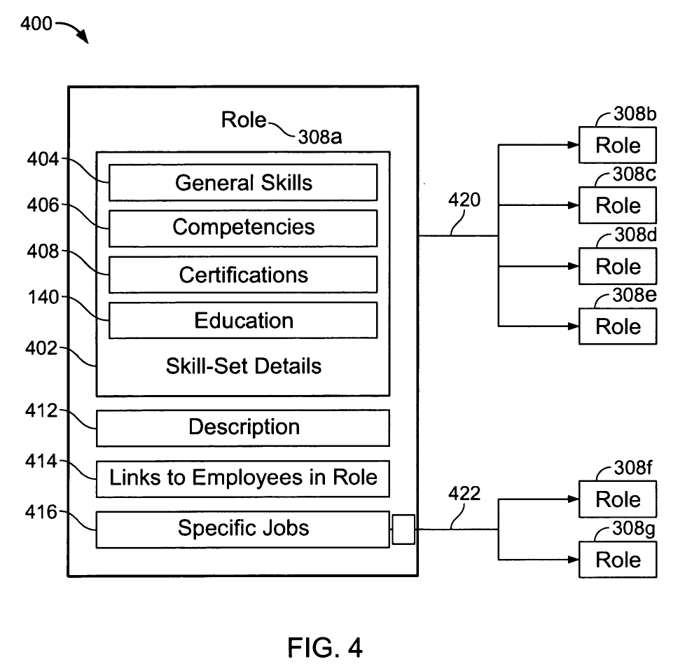

Referring to FIG. 4, each role 308 includes a skill set 402, a description 412, a link 414 to employees in the role, and a link 416 to specific jobs. Skill set 402 can include general skills 404, competencies 406, certifications 408, and education 410 associated with role 308. A description of the role 412 includes standard tasks of a person in the role. The role 308 includes a link 414 to employees in the role or a link 416 to specific jobs associated with the role 308. Links 420 and 422 link the role 308a to other roles 308b-g. The career planning tool uses the links 420 and 422 to generate a career path based on a typical or possible progression from one role to another role.

A typical progression is one in which an employee follows a standard path followed by other employees in similar situations. A possible progression is one in which a user moves to a role subsequent to the current role that is possible, but not typical such as progressing from an entry level to a manager. Links 420 and 422 associate a role 308a with typical subsequent roles (using link 420) or possible subsequent roles (using link 422). To follow link 422 and move from the current role to a role specified by a possible link 422 can require special features included in the skill set 402. A link 422 to a possible subsequent role can also link a current role to a role outside the category in which the current role is classified. For example, the career planning tool provides a link from an engineering role to a role in advertising using a possible progression link 422. In some examples, an administrator defines links 420 and 422 and enters these links into a storage module. To define a link (e.g., 420 or 422), an administrator generates a pointer from one role 308a to one of the other roles (e.g., 308b-g) defined in the organizations' taxonomy (e.g., 300).

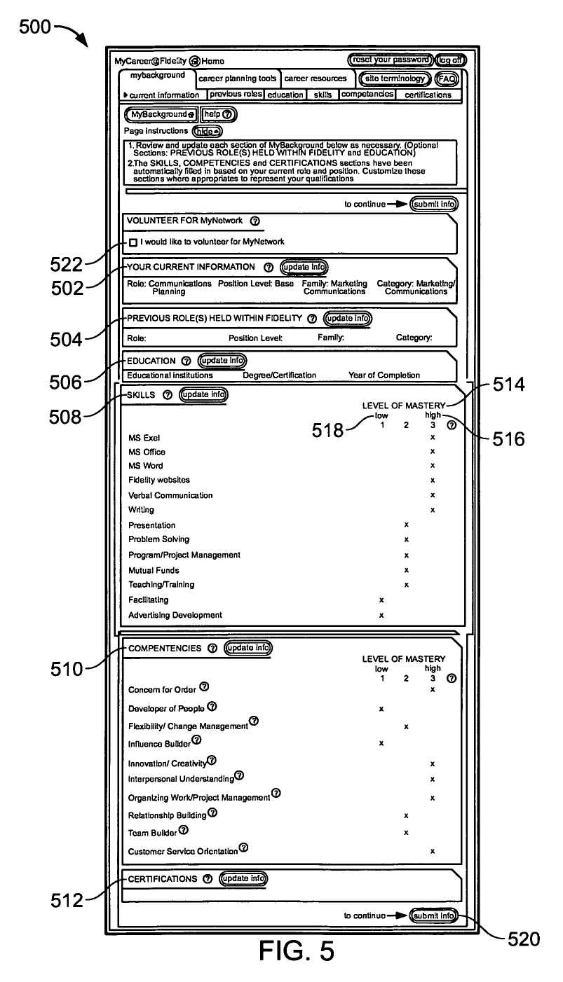

FIG. 5 illustrates a screenshot 500 of a user interface that enables a user to input background information including a current role section 502, a previous roles section 504, an education section 506, a general skills section 508, a competencies section 510, and a certifications section 512. Various features of the career planning tool rely on the background information of the user. For example, the career planning tool uses the background information to determine if a user possesses the skill set required for a different role. When the user first navigates to user interface 500, (e.g., clicks on hyper-link 116 (FIG. 1)) the career planning tool automatically populates the background based on the minimum requirements for the current role of the user. A user modifies the information, however, to reflect his current status. Background information, such as skills listed in section 508 and competencies listed in section 510, includes a scaled level of mastery 514 for each particular skill or competency. The user inputs a level of mastery according to his skill level. For example, if a user has a good understanding of writing the user selects “high” 516 as the level of mastery. If the user does not feel confident with his writing skills, the user selects “low” 518. Skills listed in section 508 can vary greatly from the use of a particular program, to problem solving skills, or teaching. Competencies listed in section 510 are traits of the employee, such as leadership and analytical thinking. When a user completes the background and selects button 520 to submit the information, the career planning tool saves the background information of the user. If the user selects to volunteer for the networking feature by checking box 522, the career planning tool makes the employee's background available for other users to view.

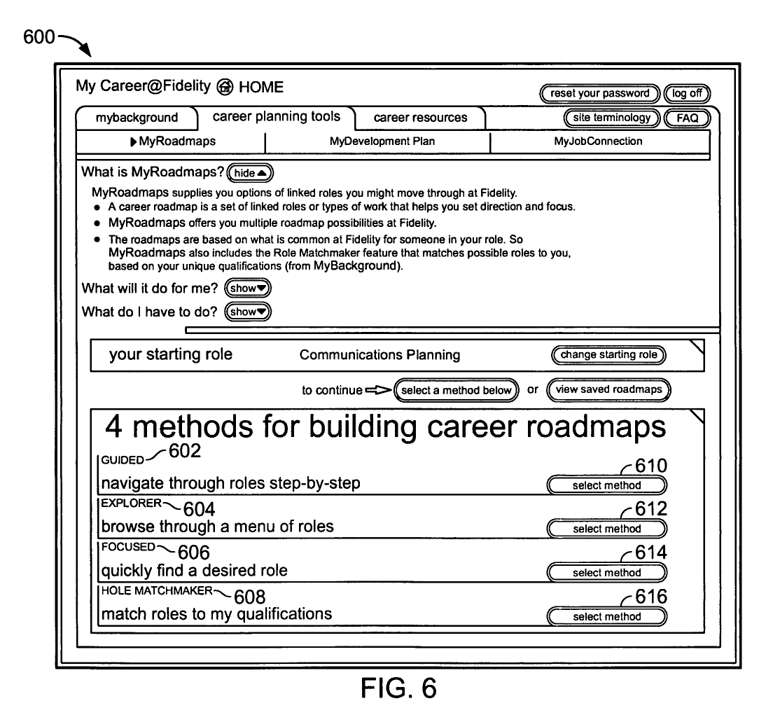

FIG. 6 illustrates a screenshot 600 of a user interface including buttons 610, 612, 614, and 616 for choosing a mode 602, 604, 606 or 608. The career planning tool generates this interface, for example, in response to the user clicking on the roadmap hyper-link 120 (FIG. 1). The career planning tool enables a user to generate a career path based on information in the background by using a guided mode 602, an explorer mode 604, a focused mode 606, or a role matchmaker mode 608.

To select a desired mode, the user clicks on the button 610, 612, 614, or 616 associated with the mode 602, 604, 606 or 608 respectively. For example, if the user desires to use the guided mode 602, the user presses button 610. The various modes assist a user in determining a desired role (e.g., 210). The guided mode 602 allows a user to step through roles one at a time. In guided mode 602, a user selects a next role linked to the current role by links 420 and 422. This process repeats in a stepwise fashion until the user chooses the final desired role 210.

Explorer mode 604 allows a user to browse a list of roles and select a desired role 210. In explorer mode 604, the career planning tool sorts the roles according to hierarchy 300 shown in FIG. 3. The user selects a category 304, a family 306, and a role 308. If a user knows the role he desires, in focused mode 606 the user directly inputs the desired role 210. This mode can be short and quick but requires the user to know exactly the role they desire. On the other hand, if a user does not know what subsequent roles he might desire, the role matcher mode 608 generates a list of roles based on the qualifications in the user's background according to a set of rules. After the user determines a desired role, the career planning tool generates a career path (e.g., 200, 204, or 206) linking a starting role (e.g., 208) to the desired role (e.g., 210).

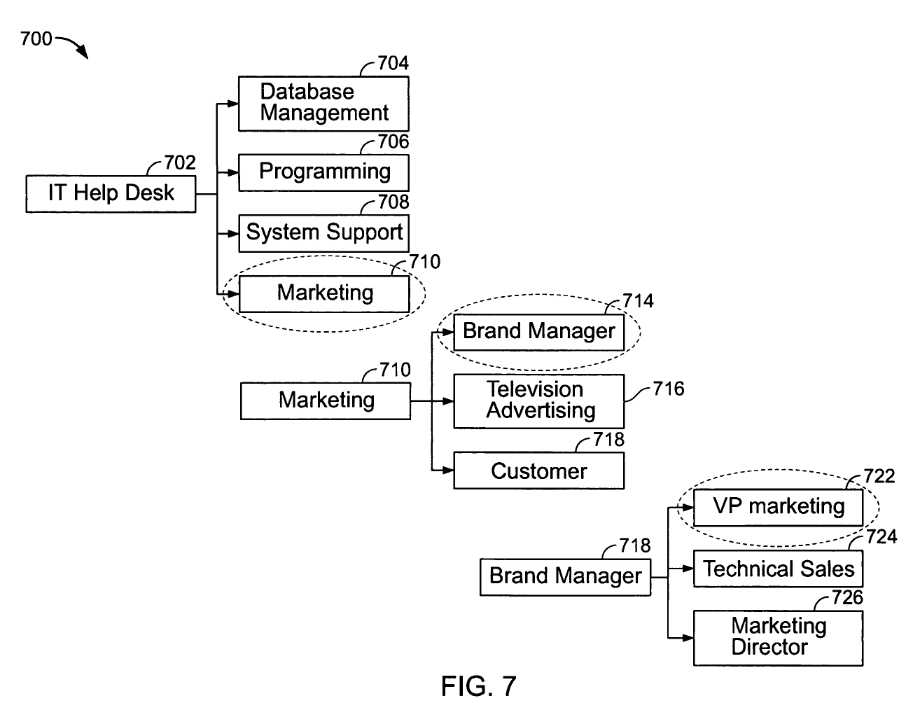

Referring to FIG. 7, guided mode 602 allows a user to step through roles one at a time creating a career path to a desired role. The career planning tool uses links 420 and 422 to determine subsequent roles. In guided mode, the career planning tool displays roles linked to the current role for user selection. For example, upon determining the current role of IT help desk 702, the career planning tool displays a list of subsequent roles including database management role 704, programming role 706, system support role 708, and marketing role 710. The user selects the role he finds most desirable.

For example, the user selects marketing role 710 (as indicated by dashed circle). Upon selecting marketing role 710, the career planning tool generates a list of roles linked to marketing role 710. This list includes brand manager role 714, television advertising role 716, and customer service role 718. The user desires to advance to a brand manager role 714 and selects brand manager role 714. In response to the user selecting brand manager role 714, the career planning tool generates a list of possible roles from brand manager role 714. This list includes VP marketing role 722, technical sales role 724, and marketing director role 726. The user selects the VP marketing role 722 as his final desired role. The career planning tool generates a career path based on the employee selections. In this example the career path would include the current role of IT help desk 702, marketing role 710, brand manager role 714, and VP marketing role 722. In this example, the guided mode generates a single career path based on the roles selected by the user, however, since multiple options are presented to the user at each step the user can generate multiple career paths using this method.

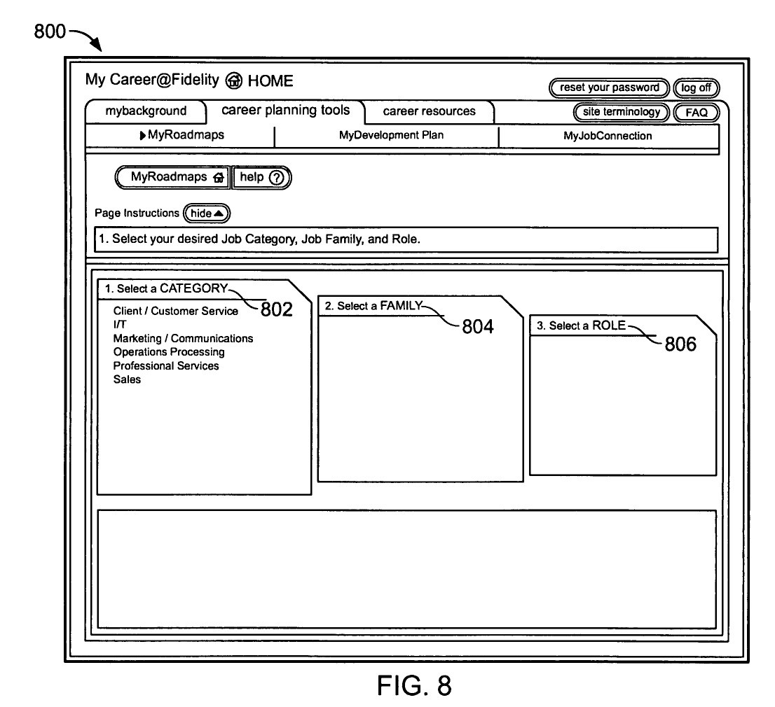

FIG. 8 illustrates a screen shot 800 of a user interface to which a user navigates when the user selects the explorer mode 604 by clicking on button 612 (FIG. 6). The explorer mode 604 includes navigating from a desired category 304 to find a particular role 308 based on the hierarchical taxonomy 300 of the organization. The career planning tool provides a list of categories 802. In response to the user selecting a particular category 304 from the list of categories 802, a list of the families 804 within the chosen category appears. In response to the user selecting a particular family 306 from the list of families 804, the career planning tool provides a list of roles 806 within the family 306. Thus, by making selections of a category 305, family 306, and role 308 from the respective lists 802, 804, and 806, the user navigates from the top level of the hierarchy shown in FIG. 3 to a particular role 308. After the user determines a particular role 308 (i.e. desired role), the career planning tool generates one or more career paths (e.g., 200, 204, or 206) linking a starting role (e.g., 208) to the particular role 308.

Focused mode 606 allows the user to directly input a desired role 210. For example, the career planning tool generates a user interface with a place for the user to enter a desired role. The career planning tool receives the desired role and creates one or more career paths between the current role of the employee and the entered desired role. This mode can be quick, but requires the user to know a desired role before generating a career path.

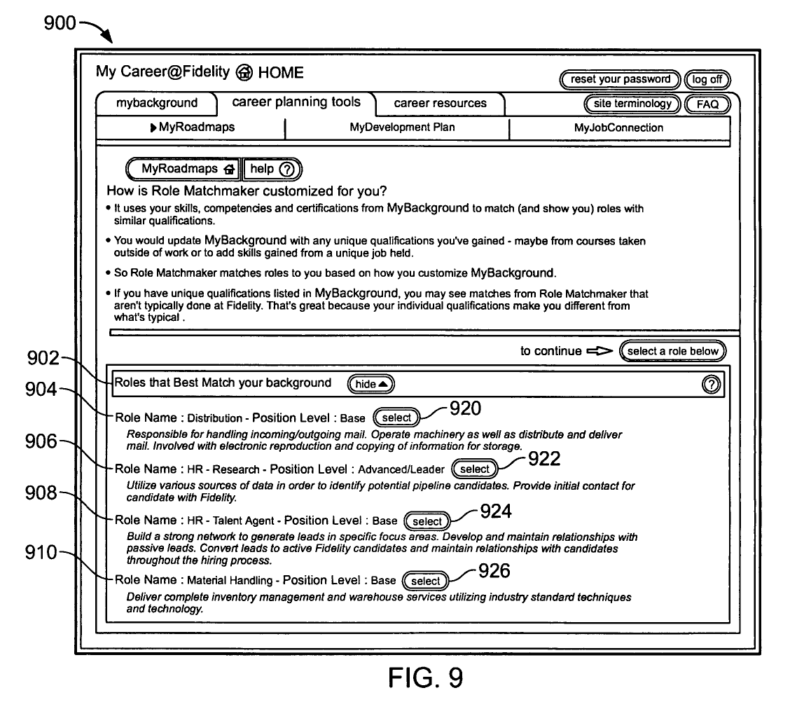

FIG. 9 illustrates a screen shot 900 of a user interface to which a user navigates when the user selects the matchmaker mode 608 by clicking on button 616 (FIG. 6). In matchmaker mode 608, the career planning tool matches a user's skill set to the skill set 402 of other roles 308. Matches of possible roles 904, 906, 908, and 910 are returned to the user. The career planning tool determines whether there is a match, for example, by comparing the skill set 402 required for a desired role to the skill set (e.g., sections 508, 510 and 512) included in the background for the employee. The role matchmaker generates a set of best matches 802, a set of close matches (not shown), and a set of career change matches (not shown). The user can select one of these roles 904, 906, 908 and 910 by pressing the select button 920, 922, 924, or 926 associated with the role.

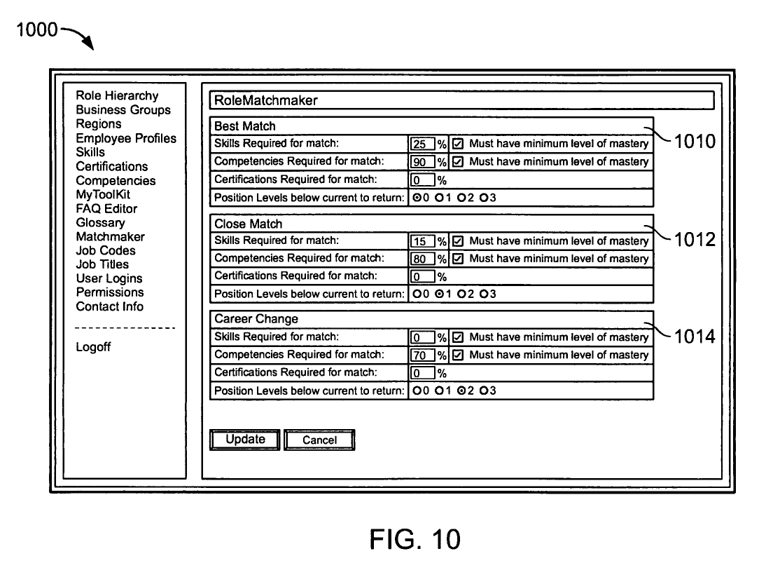

FIG. 10 illustrates a screen shot 1000 of a user interface an administrator uses to set features of the role matchmaker mode 608 for a best match 1010, a close match 1012, and a career change 1014. The role matchmaker mode 608 bases a career path on skills (e.g., section 500), competencies (e.g., section 510), and certifications (e.g., section 512) possessed by the user. An administrator sets the percentage match required between the current skills, competencies, and certifications and those of a subsequent role to generate a match. Typically, a best match 1010 most closely matches the skill set currently possessed by the user, followed by the close match 1012. A career change match 1014 includes the least percentage matching between the current and desired skill set.

In this example, a best match requires an employee to possess 25 percent of the skills necessary for a particular role and 90 percent of the competencies necessary for a particular role, but does not require the employee to have any of the certifications for the subsequent role. For the best match 1010, the career planning tool includes no positions at levels below the current level as a match.

In this example, a close match 1012 requires an employee to possess 15 percent of the skills necessary for a particular role and 80 percent of the competencies necessary for a particular role, but does not require the employee to have any of the certifications for the role. For the close match 1012, the career planning tool includes positions up to one level below the current level.

In this example, a career change 1014 requires an employee to possess 0 percent of the skills necessary for a particular role and 70 percent of the competencies necessary for a particular role, but does not require the employee to have any of the certifications for the role. For the career change 1014, the career planning tool includes positions up to two levels below the current level. An administrator sets and changes the percentages required for each type of match.

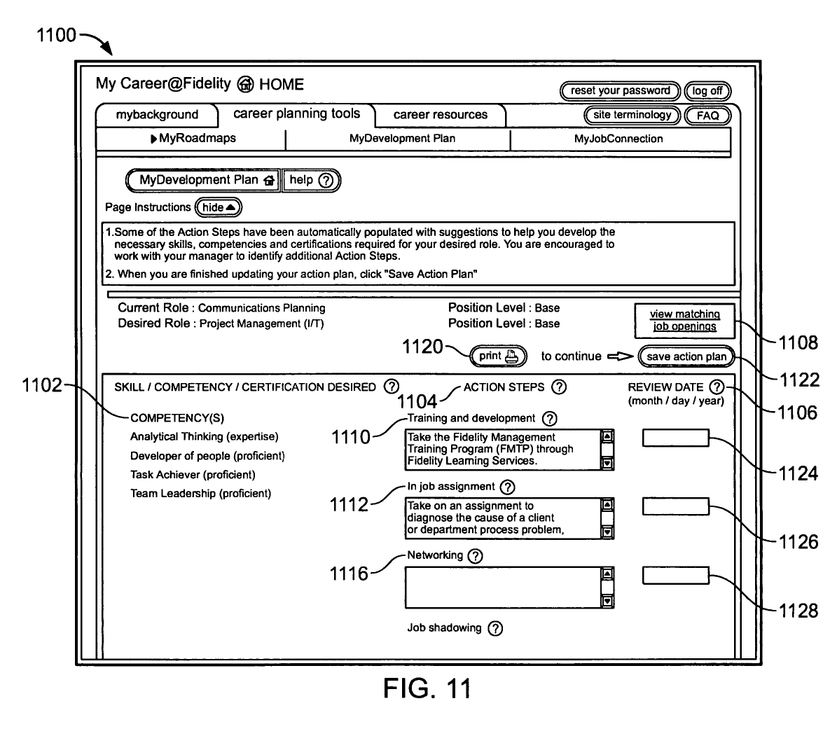

FIG. 11 illustrates a screen shot 1100 of a user interface for a development plan accessed by the user by clicking on button 122 (FIG. 1). The career planning tool generates a development plan for the user based on the current role 208, desired role 210, and qualifications included in the background for the particular user. A development plan provides an employee with a list of suggestions for improving particular skills or competencies needed for desired role 210 or for another role selected from the career path. The development plan includes a list of competencies 1102, action steps 1104, and review dates 1106. The development plan user interface includes a hyper-link to job openings 1108. The development plan bases action step recommendations on skills 404, competencies 406, and certifications 408 in the skill set 402 of the desired role. The career planning tool suggests various types of action steps 1104 and categorizes the action steps 1104 according to general types of training available. For example, the categories can include specific training 1110, taking on a particular assignment or responsibility within the current role 1112, networking to form connections 1114, and/or job shadowing 1116. The user provides a review date 1122 for review of action steps 1104, setting a goal for completing action steps 1104. The user prints the development plan by pressing print button 1120 or saves the development plan by pressing save button 1122. The user can also e-mail the saved development plan to another user such as a manager, mentor, or HR representative.

For example, a user desires to move from his current role (e.g., 208) to a different role but does not possess all of the required skill set 402 for the different role. In this example, one competency listed is leadership. An action step categorized in the training and development section 1110 to help the user improve this competency suggests the user to take a management program through the learning services. Another competency listed is analytical thinking. To improve this competency, the development plan directs the user to take on a particular in job assignment 1112 of diagnosing the cause of a problem. The career planning tool recognizes the need to increase the level of analytical thinking and leadership proficiency by comparing the information in the role with the information in the user's background.

The user chooses a date to review progress on the suggested action items. In this example, the user has not set a review date for either of these action steps. However, the user can enter the review date in the review date space 1124, 1126, or 1128. For example, based on the suggestions included in the development plan the employee recognizes the need to improve leadership skills and decides to enroll in the management training program as suggested under training and development category 1110. The user enters a review data into space 1124, 1126, or 1128 indicating a time he desires to have completed the class. The review date 1106 provides a goal for the employee to complete the training by a set time.

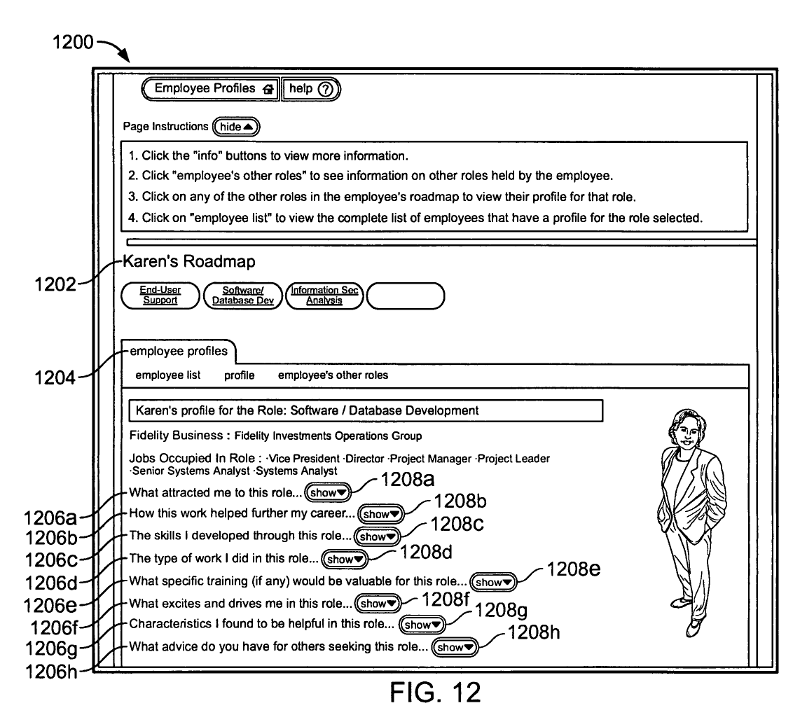

FIG. 12 illustrates a screen shot 1200, accessed by the user by clicking on hyper-link 130 (FIG. 1), that includes a career path 1202 for the employee and a profile section 1204. The employee profile section 1204 includes answers to specific questions 1206a-j regarding the role to help a user determine if they would be interested and/or qualified for the role. For example, a question 1206f might be the typical job assignments of an employee in the role. To view an employee's response to this question 1206f, the user clicks on the corresponding button 1208f.

The career planning tool can be implemented in digital electronic circuitry, or in computer hardware, firmware, software, or in combinations of them. The career planning tool can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The career planning tool can include multiple processes run on a server. The server generates results in response to user input. The results are sent to a client system and displayed as a user interface. A captured picture of the user interface is referred to as a screenshot.

Method steps of the career planning tool can be performed by one or more programmable processors executing a computer program to perform functions of the career planning tool by operating on input data and generating output. Method steps can also be performed by, and apparatus of the career planning tool can be implemented as, special purpose logic circuitry, e.g., an FPGA (field programmable gate array) or an ASIC (application specific integrated circuit). These steps can be performed in a different order than described above.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the career planning tool can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The career planning tool can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the career planning tool, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing career planning tool can include clients and servers. A client and server are generally remote from each other and typically interact through a communication network. The relationship of client and server arises by virtue of computer programs running on the respective computers and having a client-server relationship to each other.

The career planning tool has been described in terms of particular embodiments. Other embodiments are within the scope of the claims that follow. The following are examples for illustration only and not to limit the alternatives in any way. The steps of the invention can be performed in a different order and still achieve desirable results.

For example, although the hierarchical taxonomy shown in FIG. 3 is for an organization, the taxonomy could relate to an entire industry or include multiple industries and organizations forming a nationwide job system. In this situation, the career planning would not be limited to roles within a single organization, but would include roles from multiple organizations.

In another example, the career planning tool can be based on specific jobs instead of roles such that a user selects a particular job and a career path is generated from the current job to the desired job. On the other hand, the career planning tool can be less specific than the roles within an organization and be based instead on job types to provide a career path for moving between industries or job types. For example, the method might include suggesting training to move from an engineering role to a marketing role either within the company or across multiple companies.

In another example, career paths are used not only to plan a career within an organization but also to learn about a different organization and determine a role of interest within the different organization. This method allows an employee to consider moves between businesses. For example, a user may determine a role of interest within a first company and the career planning tool would provide a list of roles in other companies that would utilize the same set of skills and/or interests.

Other embodiments are within the scope of the following claims:

1. A method comprising
storing a set of roles for an organization,
storing user information for a user, the user information including a first role and a second, later role, and
automatically generating a career path based on the set of roles, the first role, and the second role.

2. The method of claim 1 further comprising generating a training recommendation based on the career path.

3. The method of claim 1 further comprising:
comparing a first set of qualification data included in role information for a role in the career path with a second set of qualification data included in the user information; and
identifying a qualification included in the first set of qualification data but not in the second set of qualification data.

4. The method of claim 2 wherein generating a training recommendation includes determining an association between the qualification and a training program.

5. The method of claim 1 wherein the career path includes a set of intermediate roles between the current role and the second role.

6. The method of claim 1 further comprising providing a list of roles from the set of roles.

7. The method of claim 6 wherein storing the user information further comprises: displaying available roles from a list of roles; and
receiving a user selection from the displayed available roles.

8. The method of claim 1 further comprising
sorting roles from the set of roles according to qualification data, and
selecting roles with a particular set of qualifications.

9. The method of claim 1 wherein
determining the second role includes receiving a user input.

10. The method of claim 1 further comprising saving the career path.

11. The method of claim 1 further comprising sending the career path associated with the user to a second user.

12. The method of claim 11 wherein the second user includes a manager.

13. The method of claim 11 wherein the second user includes a human resources employee.

14. A method comprising
providing links between roles that may be part of a career path,
receiving a first role and a second role based on to user input, and
generating a career path including a set of roles between the first role and the second role based on the links between roles.

15. The method of claim 14 wherein the links include binary links.

16. The method of claim 14 further comprising displaying the set of roles to a user.

17. The method of claim 14 further comprising determining a path with the least number of roles between a first role and a second role.

18. The method of claim 14 further comprising determining a path with a typical progression of roles between a first role and a second role.

19. The method of claim 14 further comprising determining a plurality of paths between a first role and a second role.

20. The method of claim 19 further comprising receiving a path selection corresponding to user input.

21. The method of claim 14 further comprising using a job category to obtain the second role corresponding to the user input.

22. The method of claim 14 further comprising using job family within a job category to obtain the second role corresponding to the user input.

23. The method of claim 14 further comprising determining the links between roles based on skill and competency measures.

24. A method for determining a path between two roles, the method comprising
providing a list of roles,
providing rules to govern links between roles, and
generating a career path between a first role and a second role based on the rules.

25. The method of claim 24 further comprising generating the rules based on a possible progression between two roles.

26. The method of claim 24 wherein the rules include skill set data.

27. The method of claim 24 wherein the rules include competency measures

28. The method of claim 24 wherein the rules include certifications.

29. The method of claim 24 further comprising providing rules further comprises receiving rules based on a user input.

30. The method of claim 24 wherein providing a second set of rules corresponding to an accelerated path.

31. The method of claim 30 wherein the accelerated path includes less intermediate roles than a typical career path.

32. The method of claim 24 further comprising generating a set of links between two roles such that no rules are violated.

33. The method of claim 24 wherein the rules include training suggestions for a particular role.

34. The method of claim 33 further comprising generating a list of training suggestions for a progression from a fist role to a second role.

35. A method comprising,
providing a plurality of backgrounds, each background associated with a respective employee,
sorting the backgrounds by role, and
sending backgrounds to a user in response to user input.

36. The method of claim 35 further comprising selecting a role and set of backgrounds based on user input

37. The method of claim 35 further comprising contacting the employee associated with a particular background.

38. The method of claim 37 wherein contacting includes e-mailing.

39. The method of claim 37 wherein contacting includes establishing an internet chat session.

40. The method of claim 35 further comprising allowing the employee to select whether their background information can be viewed by other users

41. The method of claim 1 further comprising displaying job openings associated with a role in the career path.
